(19) United States
(12) Patent Application Publication
(10) Pub. No.: US 2010/0013621 A1
(43) Pub. Date: Jan. 21, 2010

(54) Illuminated Gear Selection Indicator

(76) Inventor: Thomas V. Kazyaka, Gualala, CA (US)

Correspondence Address: STAINBROOK & STAINBROOK, LLP, 412 AVIATION BOULEVARD, SUITE H, SANTA ROSA, CA, 95403, US

(21) Appl. No.: 12/173,773

(22) Filed: Jul. 15, 2008

(51) Int. Cl. B60Q 1/00

(52) U.S. Cl. 340/456; 116/28.1

(57) ABSTRACT

An improved gear selection indicator principally for use in a motor vehicle having a manually operated shift lever connected to a motor vehicle manual or automatic transmission, and including a shift knob sleeve placed over the vehicle gear shift lever, and an illuminated display disposed in the opening of the sleeve. The display includes a gear shift pattern plate with LEDs disposed around a shift pattern. The lights are controlled by a display circuit board having a microcontroller. A plurality of electro-magnetic position sensors positioned proximate the transmission case are activated by one or more magnets disposed on the gear shift lever. A sensor circuit board in electrical communication with the position sensors and the display board microcontroller detects any activation of the position sensors and sends a signal to the display board microcontroller which maps the data onto the LED display for an illuminated gear selection output.

### CROSS REFERENCES TO RELATED APPLICATIONS

The present application claims the benefit of the filing date of U.S. patent application Ser. No. 11/877,576, filed Oct. 23, 2007, which claims the benefit of U.S. Provisional Patent Application Ser. No. 60/862,578, filed Oct. 23, 2006 (Oct. 23, 2006).

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

This invention relates generally to motor vehicle control apparatus and display instrumentation. More particularly, the present invention relates to manual gear shifts, and still more particularly to an improved gear selection indicator for manual transmissions which provides means to control and regulate the level of boost available from a turbocharged engine when a specific gear is engaged.

2. Discussion of Related Art Including Information Disclosed Under 37 CFR §§1.97, 1.98

The present invention is an improvement on an earlier invention by the present inventor, as described, disclosed, and claimed in U.S. Pat. No. 5,552,761, issued on Sep. 3, 1996. The '761 patent is incorporated in its entirety herein by reference.

Since the above-indicated patent issued, several patents showing related art have also issued, among them:

U.S. Pat. No. 5,900,678 to Rodgers, which teaches a novel gear shift knob that flashes random light patterns. The knob contain circuitry including a battery, a motion responsive switch, a timing circuit, and an illumination circuit with the circuitry responsive to the OFF-to-ON transition of said motion responsive switch to start the timing circuit timing interval. The light source is molded into clear plastic and encapsulated with the timing and illumination circuits. The motion causing switch operations is vehicle motion itself, though it may also be the motion of shifting gears. It is not adapted for showing a particular gear into which the vehicle has been shifted.

U.S. Pat. No. 6,044,790 to Murakami, discloses a manual operating apparatus for an automatic transmission is structured such that a first shift line and a second shift line corresponding to a shift direction of a shift lever are differentially displayed in an illuminated display. The shift lever moves along the first shift line and the second shift line and rotates around a pin. At a position near the lower end of the shift lever a position detecting switch is turned to an ON state when the shift lever is positioned at a position of the first shift line and to an OFF state when the shift lever is positioned at a position of the second shift line. The position detecting switch is connected to a first electric lamp and a second electric lamp through a controller.

U.S. Pat. No. 6,072,390 to Dourra, et al., shows a sensing system for detecting the position of a manually operated shift lever in an automatic transmission. It includes a plate movable in response to movement of a shift lever. The plate includes a contact surface having a predetermined pattern of electrically conductive and non-conductive areas. An electrical sensor unit is mounted in the transmission and positioned to communicate with the contact surface of the plate. At least five electrical contacts engage the conductive and non-conductive areas on the contact surface generate binary codes having combinations that are indicative of the shift lever position in each of the predetermined operating modes. The engagement between the contact members and the contact surface further generates at least four unique binary codes indicative of the transitions between the predetermined operating modes. These four unique binary codes indicate to a controller the specific transition zone the shift lever is positioned within.

U.S. Pat. No. 6,137,399 to Westberg, et al., discloses a tachometer for mounting on the display dashboard of racing vehicles. The analog tachometer includes a shift indicator designed to monitor an engine speed or RPM profile and utilize information from the profile to operate the shift setpoint selection, shift display enablement and the shift indicator.

The foregoing patents and prior art apparatus reflect the current state of the art of which the present inventor is aware. Reference to, and discussion of, these patents and devices is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described herein. In particular, there remains a need for a lightweight visual display for use in detecting and displaying gear selection in both automatic and transfer case (manual) transmissions. The present invention elegantly meets this need.

### BRIEF SUMMARY OF THE INVENTION

The present invention is an improved gear selection indicator for use in connection with both manual and automatic transmissions.

It is an object of the present invention to provide a new and improved gear selection indicator apparatus which eliminates redundancy in manufacturing specialized shift knobs.

It is another object of the present invention to provide a new and improved gear shift selection indicator that facilitates easy installation of an after market illuminated gear selection indicator for manual transmissions.

A further object or feature of the present invention is to provide a new and improved sensor ring for an illuminated gear shift selection indicator.

A still further object of the present invention is to provide an illuminated gear shift indicator for installation on a gear shift lever that is powered by a vibration energy generation system and wirelessly communicates system status to a display unit.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention which will form the subject matter of the claims appended hereto.

Accordingly, before explaining the preferred embodiment of the disclosure in detail, it is to be understood that the disclosure is not limited in its application to the details of the construction and the arrangements set forth in the following description or illustrated in the drawings. The inventive apparatus described herein is capable of other embodiments and of being practiced and carried out in various ways.

Also, it is to be understood that the terminology and phraseology employed herein are for descriptive purposes only, and not limitation. Where specific dimensional and material specifications have been included or omitted from the specification or the claims, or both, it is to be understood that the same are not to be incorporated into the appended claims.

As such, those skilled in the art will appreciate that the conception, upon which this disclosure is based may readily be used as a basis for designing other structures, methods, and systems for carrying out the several purposes of the present invention. It is important, therefore, that the claims are regarded as including such equivalent constructions as far as they do not depart from the spirit and scope of the present invention. Rather, the fundamental aspects of the invention, along with the various features and structures that characterize the invention, are pointed out with particularity in the claims annexed to and forming a part of this disclosure. For a better understanding of the present invention, its advantages and the specific objects attained by its uses, reference should be made to the accompanying drawings and descriptive matter in which there are illustrated the preferred embodiment.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a schematic perspective view showing a prior art gear shift selection indicator invented by the present inventor and disclosed in U.S. Pat. No. 5,555,721;

FIG. 2 is an upper perspective view showing the improved gear shift selection indicator of the present invention;

FIG. 3 is an upper exploded perspective view showing the apparatus of FIG. 2;

FIG. 4 is an upper perspective view showing the support frame of the inventive apparatus;

FIG. 5 is an upper perspective view showing an alternative embodiment of the inventive gear shift selection indicator;

FIG. 6 is a side view in elevation of the apparatus of FIG. 5;

FIG. 7 is a partial cross-sectional schematic side view in elevation showing the layout of the structural and functional elements comprising the inventive apparatus;

FIG. 8A is a schematic software flow diagram showing the sensor board routine start up;

FIG. 8B is a schematic software flow diagram showing the display board routine start up;

FIG. 9 is a schematic block diagram of the electronic components of the inventive apparatus;

FIG. 10 is a perspective view showing a second preferred embodiment suited for use with a floor mounted gear shift for a manual transmission; and

FIG. 11 is a side view in elevation thereof.

### DETAILED DESCRIPTION OF THE INVENTION

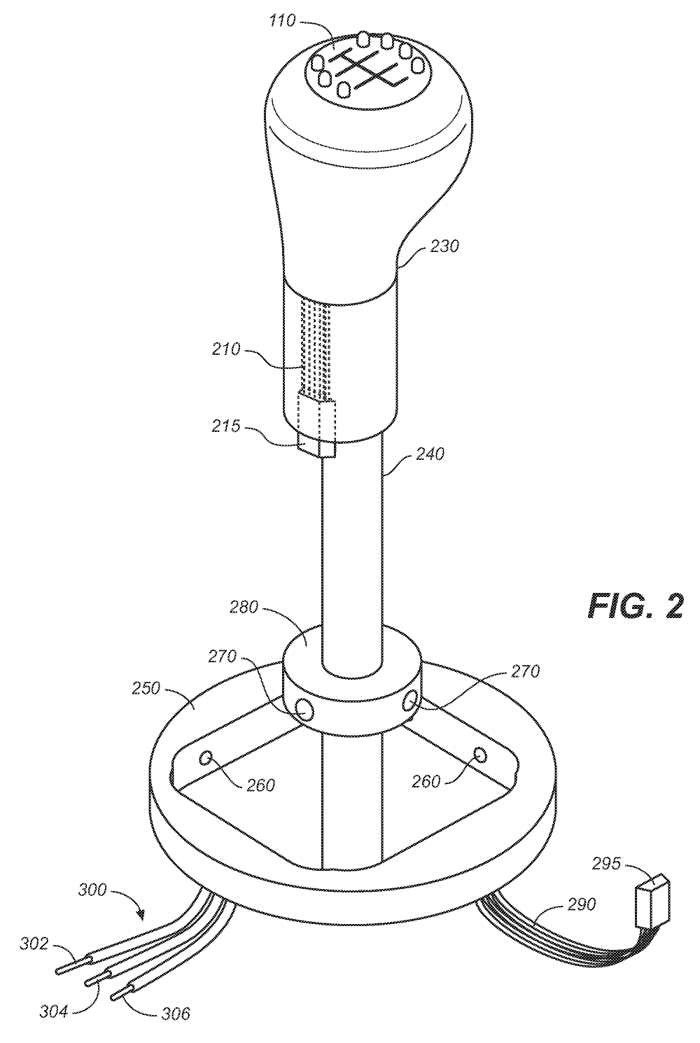

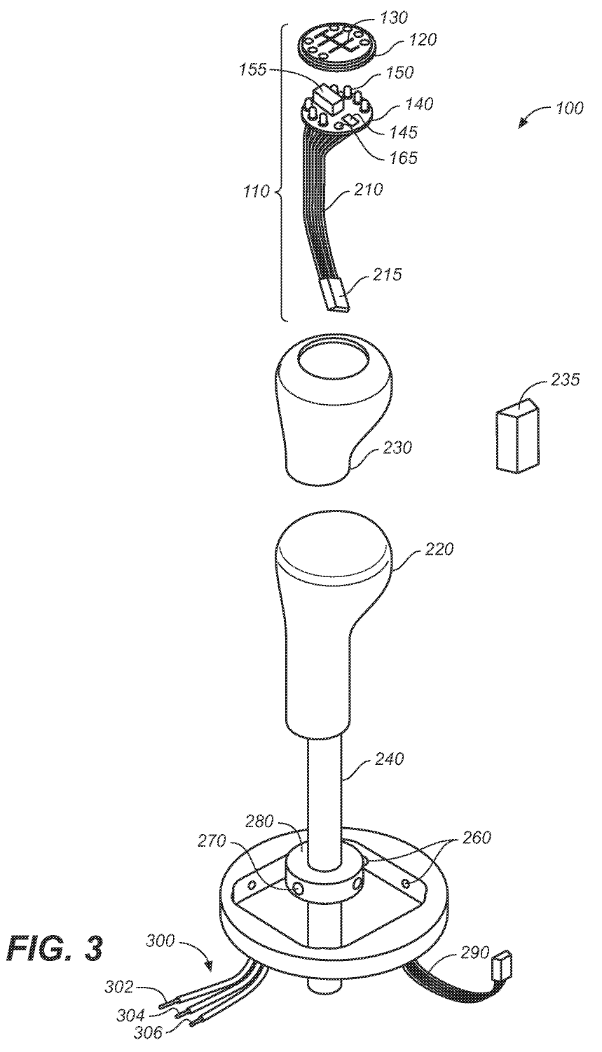

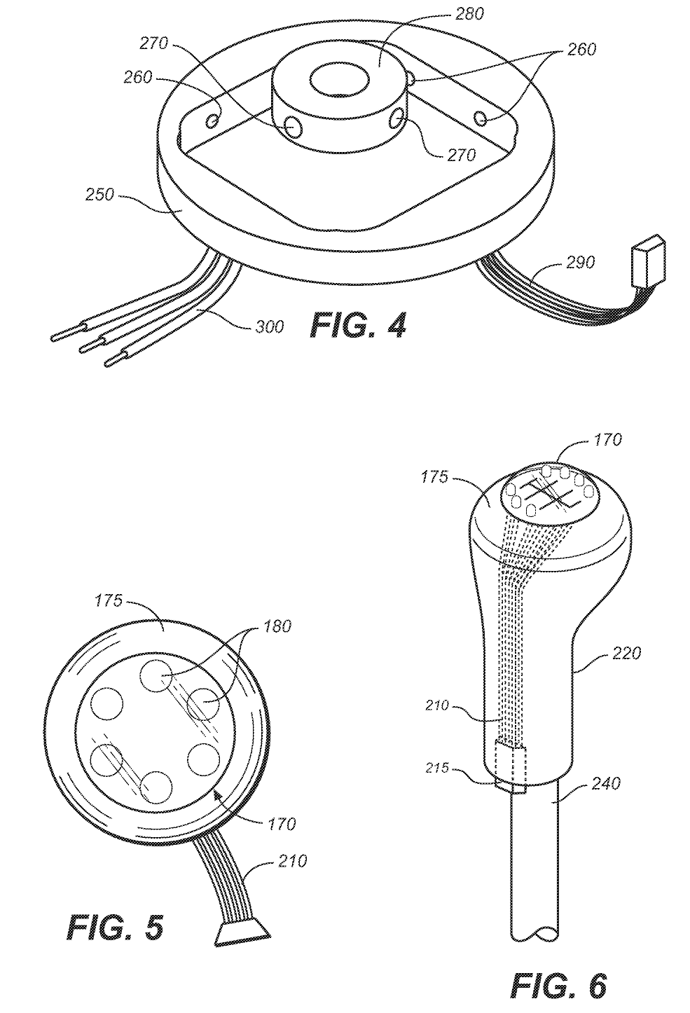

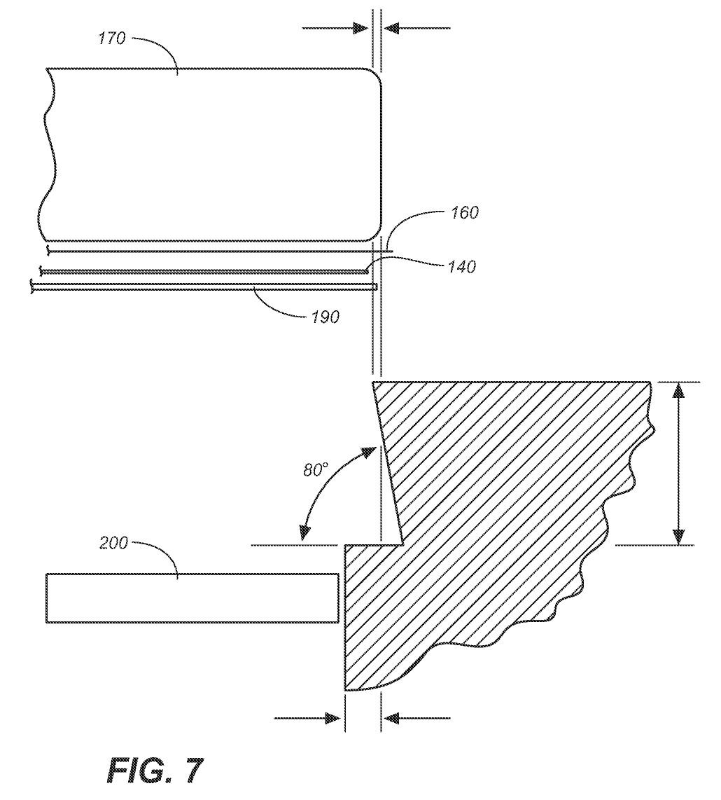

Referring to FIGS. 2 through 11, wherein like reference numerals refer to like components in the various views, there is illustrated therein a new and improved gear selection indicator which provides an illuminated display showing a vehicle driver the gear he or she has presently selected for vehicle operation. The inventive apparatus is generally denominated 100 herein.

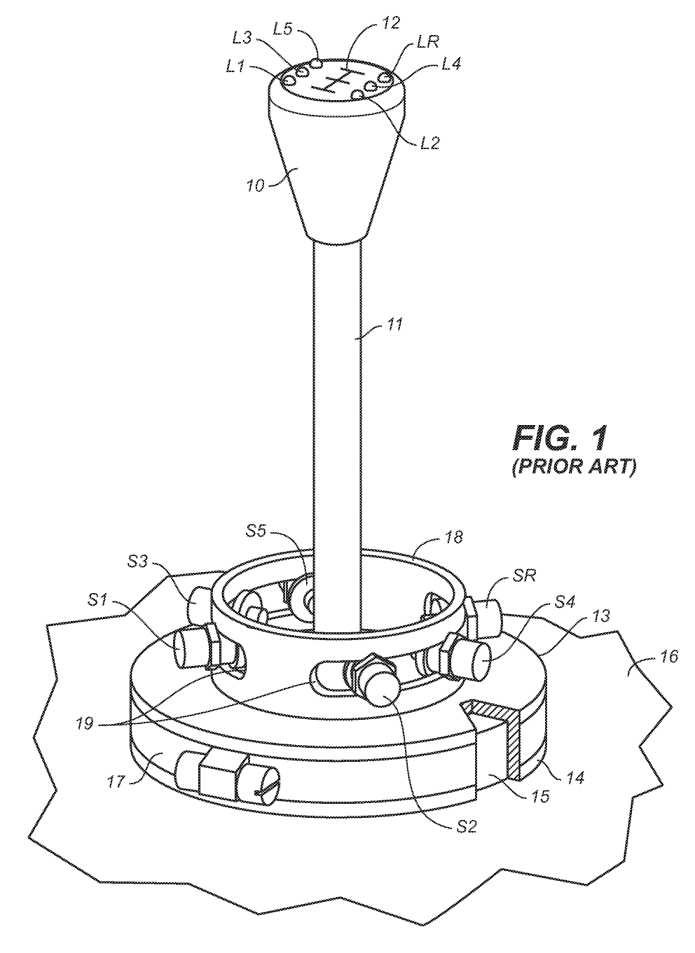

Referring first to FIG. 1, there is shown a prior art apparatus invented by the present inventor. This apparatus includes a knob 10 adapted for mounting to the top end of a conventional shift lever 11. Knob 10 includes indicia 12 for indicating the usual gear positions, and includes the numbers “1”, “2”, “3”, “4” and “5”, and the letter “R”, which are arranged to graphically represent the shift pattern of lever 11. A set of lights L1-L5, and LR are arranged on knob 10 proximate indicia “1” to “5”, and “R”, respectively, in two rows of three lights each that correspond to the shift pattern of lever 11. An annular mounting frame 13 includes a lower portion 14 secured on a cylindrical portion 15 of a conventional manual transmission 16 with a hose clamp 17. Frame 13 includes a top portion 18 with a pair of horizontal slots 19 that adjustably receive normally-off, momentary switches S1-S5, and SR.

Referring now to FIGS. 2-4, there is shown a first preferred embodiment 100 of an improved gear shift selection indicator apparatus. The apparatus broadly comprises an illuminated display 110, which includes a gear shift pattern indicia plate 120 having a semi-transparent shifting pattern 130 for the vehicle in which the apparatus is to be installed. The display further includes a light diffuser 140 which spreads light from one of a selectively illuminated micro lights, such as LEDs, photon LEDs, fiber optic light tips, or other light source. Preferably, the light source is an LED array 150, and the illumination from the array is diffused by the light diffuser to and through the shifting pattern while also specifically illuminating a light showing a gear selected for operating the vehicle.

In a second preferred embodiment (FIGS. 5-7), the shift pattern plate may be replaced by a shifting pattern decal 160 affixed to the light diffuser, and the light display (or LED array) is preferably protected and covered by an acrylic lens 170 having a plurality of partial bores 180 to accept and accommodate the LEDs. Additionally, a green lens 190 may be installed under the light diffuser, and immediately under the green lens is provided a circuit board 200 electrically connected to the light array and having a data transmission cable 210 with an end connector 215 embedded in a lower portion of a shift sleeve 220 for connection to the sensor ring (and power, as described below). The acrylic lens preferably includes a beveled edge such that a ring 175 can be installed over the lens and employed to provide a snap-on configuration which secures the acrylic lens, diffuser, pattern decal and green lens to the shift knob 220.

In each embodiment, but referring now back to FIGS. 2-4, in the first preferred embodiment the display portion is attached to a rubberized sock 230 that stretches to conform and fit tightly over the shaft of the shift knob 220. This secures the illuminated display in a position for easy viewing by the vehicle driver.

The gear shift knob 220 is installed on a shift lever 240, which is, in turn, connected to transmission linkage housed in a transmission case (not shown) in a manner well known in the art. The display circuit board is electrically connected to a sensor ring circuit board, which, in turn is connected to a sensor ring 250 clamped or form fit to the transmission case. The sensor ring includes a plurality of electro-magnetic position sensors 260, such as magnetostrictive position sensors or Anisotropic Magneto-Resistive (AMR) sensors, which respond to the proximity of magnets 270 incorporated into the circumferential outer side of an annular shift lever magnetic activation ring 280 installed coaxially over the shift lever. The sensor ring circuit board(s) (described below) includes data transmission wire harnesses 290 having a connector 295 for coupling to the display circuit board, and conductors 300 for connection to power 302, ground 304, and, an auxiliary line for connection to the vehicle's on-board computer for such options as voice activation and turbo control.

Other features of note include a rechargeable power source 155, available for use when gear selection is important even when a vehicle electrical system is inoperative, and a vibration mechanism 235 for generating energy that can be harvested by a rechargeable capacitor for running the wireless system. Such a device might comprise a piezo-electric energy generating vibrator connected to a rechargeable capacitor through a capacitor charging circuit. Alternatively, vibration mechanism can be a low voltage vibrating motor either directly or indirectly connected to power conductor 302 and connected to the display circuit board. The display board microprocessor may be programmed to actuate a perceivable vibration from the vibration motor when the gear shift lever is put into reverse, when a user frequently covers the top of the gear shift knob with his or her hand.

The electro-magnetic position sensors are separated and aligned to prevent interference with one another, so that individual position sensors or combinations of position sensors can be utilized to identify a gear selection using firmware provided in the circuit board that corresponds to the vehicle shifting pattern.

Once a gear is detected and identified by the circuit board, a signal is sent to the display, and optionally, a signal may also be sent, either via the data transmission cables or via an RF signal (e.g., bluetooth) generated by a wireless receiver and antenna 145. The signal may be sent to the vehicle's on-board computer to automatically regulate the available boost in a turbocharged engine, which is affected, in part, by the gear selected. Accordingly, the present invention provides means to transmit performance data to the vehicle computer control system to improve performance and efficiency. The wireless receiver and antenna may also replace the data transmission cables, such that a transmitter disposed on the sensor ring or sensor board (not shown) sends an RF signal which is received by the wireless receiver 145, and the receiver sends a signal to the display board microcontroller to activate an appropriate gear selection indication.

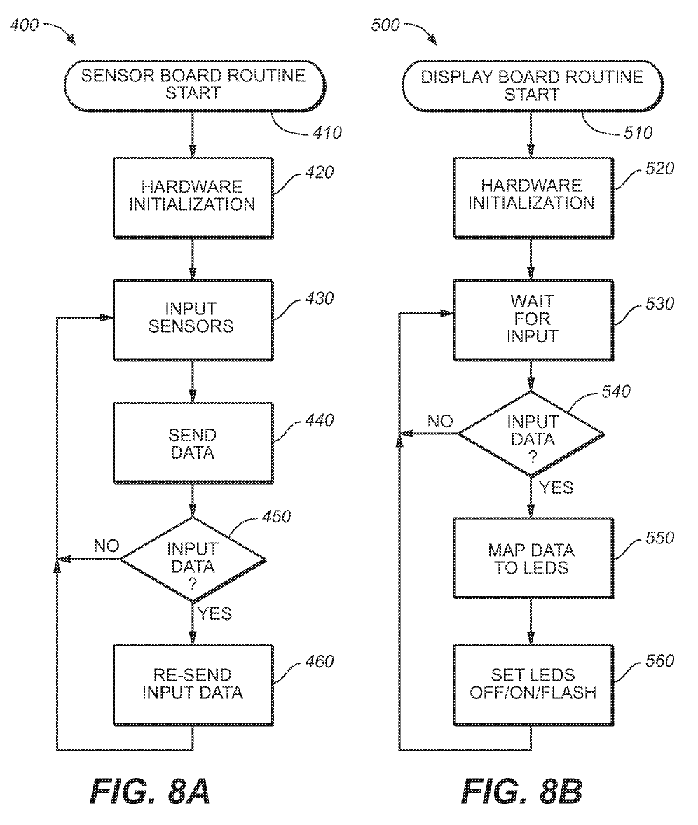

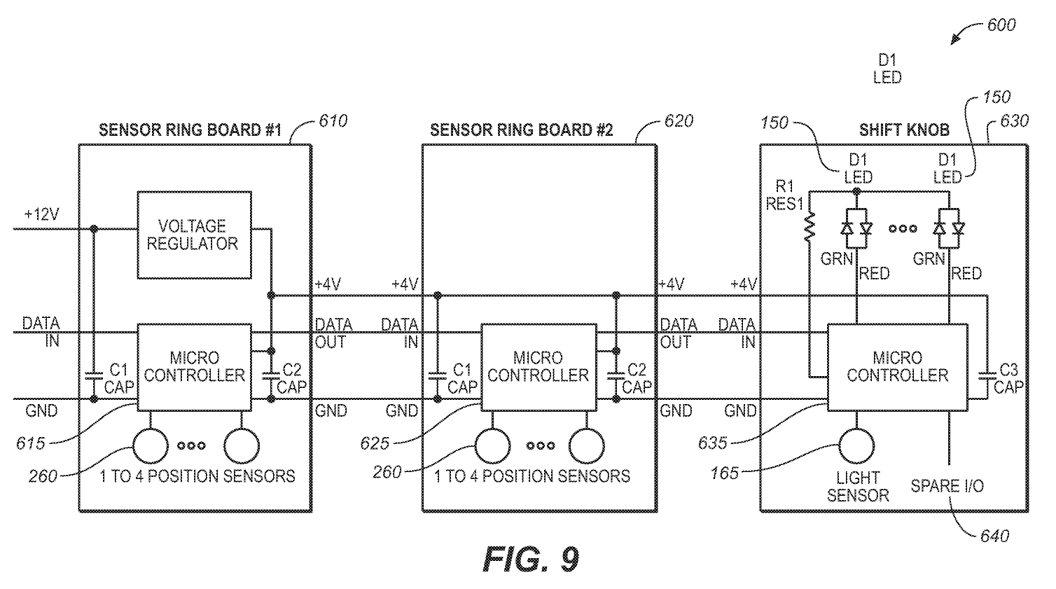

FIGS. 8-9 show the functional elements comprising the hardware 600 and software (or firmware) 400 and 500, controlling the position sensors and LED display components of the inventive gear selection indicator. These include first and second sensor ring circuit boards 610, 620, each having a microcontroller, 615, 625, respectively, each having outputs to a display circuit board 630 having a microcontroller 635 having outputs to the shift knob LEDs 150. Ambient light sensor 165 provides input to microcontroller 635 which adjusts the LED output intensity in accordance with ambient light, such that the display is brighter with more ambient light and less bright as the ambient light diminishes. Such a device is known, and an exemplary device is the AMI-74980x ambient light sensor produced and sold by AMI Semiconductor, Inc., of Pocatello, Id.

At vehicle start up, when the vehicle electrical system is turned on (whether ignition is completed or not), the sensor board and display boards each go through a start up routine 410, 510 respectively. The sensor board initializes the hardware 420 and detects the current condition 430 of the position sensors, which data is sent 440 to the display board. The board is then readied 450 for subsequent shift lever input, which if not received loops back to the current condition of the position sensors, and which when received sends a new signal 460 to the display board so as to change the LED display indication.

Display board start up 510 includes a hardware initialization 520 and an ambient light detection step 530 for scaling output to the display LEDS. If not input is received from the sensor board 540 the system loops back to the initial conditions. When input is received, 540, the system maps the data 550 to the LEDs and sets the LEDs to an appropriate display condition 560—either off, on, or flashing. The intensity of the display is scaled by adjustments made according to the ambient light detected by the ambient light sensor. The system is then readied for further inputs.

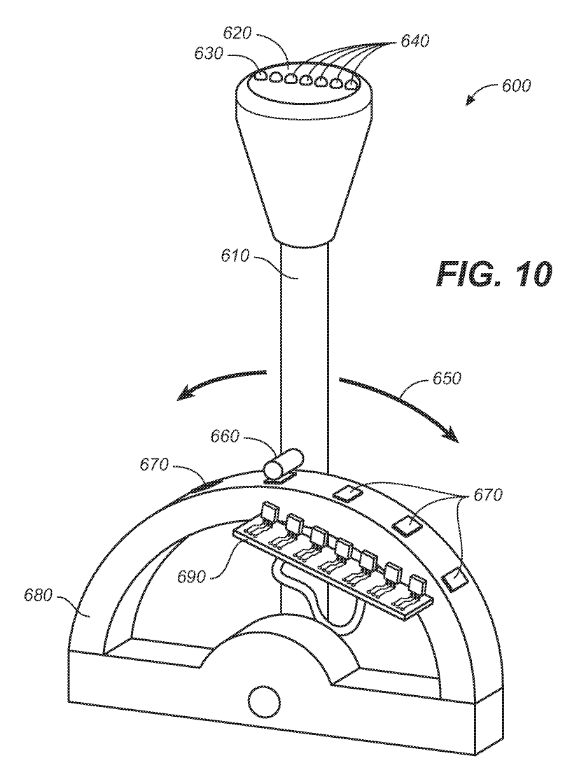

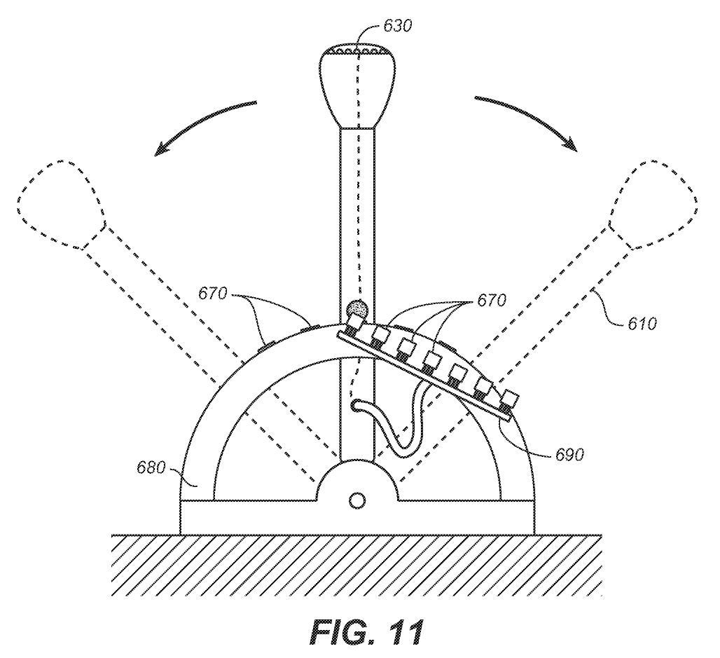

Referring next to FIGS. 10 and 11, there is shown in schematic form a third preferred embodiment 600 of the gear selection indicator of the present invention, specifically adapted for use with a floor mounted gear shift lever 610 employed in a manual transmission system. In this embodiment, the illuminated display 620 depicts the gear selections available in a manual transmission, and the gear shift pattern indicia plate 630 includes a shifting pattern 640, perhaps even a simple linear array of LEDs. Otherwise, the display includes all of the structural and operative elements of either the first or second preferred embodiments.

Attachment of the gear shift lever employed in this embodiment is shown in simplified schematic form to illustrate the simple arrangement of the operative electronic elements. Because the shift lever is pivotally attached to the transmission case and generally moves in a simple arc 650, a single magnet 660 may be affixed to the shift lever (or an element that moves coincidentally with the shift lever) to stimulate a plurality of electro-magnetic position sensors 670, arranged either in an arcuate manner on a stationary frame element 680 or in immediate proximity to a sensor circuit board 690 disposed alongside a moving frame element (also shown here as 680. In either configuration, the magnet is brought into proximity with one position sensor for each gear position.

As in the earlier described embodiments, the position sensor circuit board includes data transmission wire harnesses having a connector for coupling to the display circuit board, and conductors for connection to power, ground, and to an auxiliary line for connection to the vehicle's on-board computer.

Accordingly, in its most essential aspect, the third preferred embodiment of the improved illuminated gear selection indicator of the present invention comprises a shift knob mounting element for placement over the gear shift lever and having an opening at an upper end; an illuminated display disposed in the opening of the upper end of the shift knob mounting element and having a gear shift pattern indicia plate with an illuminated shift pattern having terminal points associated with a gear selection; a plurality of light emitting elements, each located proximate a terminal point in the shift pattern; a display circuit board with a microcontroller for controlling the output to the light emitting elements of the display; a plurality of electro-magnetic position sensors; a magnet operatively connected to the shift lever, such that as the gear shift lever is moved to change gears, the magnet activates one of the electro-magnetic position sensors; a sensor circuit board in electrical communication with the electro-magnetic position sensors and having a microcontroller for detecting the activation of the electro-magnetic position sensors; and a wire or antenna for transmitting data from the said sensor circuit board to the display circuit board.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. An improved illuminated gear selection indicator for installation on a gear shift lever connected to transmission linkage housed in an automatic transmission case, comprising:
a shift knob mounting element for placement over the gear shift lever and having an opening at an upper end;
an illuminated display disposed in the opening of said upper end of said shift knob mounting element, said illuminated display including a gear shift pattern indicia plate having a shift pattern displayed thereon, said shift pattern including terminal points indicating a gear selection;
a plurality of light emitting elements, each located proximate a terminal point in said shift pattern for providing an illuminated indication of a gear selection;
a display circuit board having a microcontroller for controlling the output to said light emitting elements;
a plurality of electro-magnetic position sensors;
a magnet operatively connected to the shift lever, such that as the gear shift lever is moved to change gears, said magnet activates one of said electro-magnetic position sensors;
a sensor circuit board in electrical communication with said electro-magnetic position sensors and having a microcontroller for detecting the activation of said electro-magnetic position sensors; and
signal transmission means for sending data from said sensor circuit board to said display circuit board.

2. The apparatus of claim 1, wherein said shift knob mounting element is a deformable sleeve.

3. The apparatus of claim 2, wherein said deformable sleeve is a rubber sock.

4. The apparatus of claim 1, wherein said light emitting elements are light emitting diodes.

5. The apparatus of claim 1, wherein said electro-magnetic position sensors comprise magnetostrictive position sensors.

6. The apparatus of claim 1, wherein said electro-magnetic position sensors comprise anisotropic magneto-resistive sensors.

7. The apparatus of claim 1, wherein said signal transmission means comprises a data transmission cable connecting said at least one sensor circuit board and said display circuit board.

8. The apparatus of claim 1, wherein said signal transmission means comprises a wireless receiver/antenna coupled to said display circuit board, and a transmitter coupled to said sensor circuit board for sending a RF signal to said wireless receiver/antenna when said sensor ring circuit board detects a signal from said position sensors.

9. The apparatus of claim 1, further including a vibrating motor connected to said display circuit board microcontroller, wherein said vibrating motor provides a perceivable vibration when the vehicle gear shift lever is put into the reverse gear position.
